(19) United States
(12) Patent Application Publication
(10) Pub. No.: US 2025/0252309 A1
(43) Pub. Date: Aug. 7, 2025

(54) HARDWARE-FRIENDLY AND PARAMETER-EFFICIENT TUNING OF NEURAL NETWORKS

(71) Applicant: GDM Holding LLC, Mountain View, CA (US)

(72) Inventors: Hanjun Dai, Atlanta, GA (US); Bo Dai, San Jose, CA (US); Mengjiao Yang, Berkeley, CA (US); Azade Nova, San Jose, CA (US); Dale Eric Schuurmans, Edmonton (CA); Sanjiv Kumar, Jericho, NY (US); Yixin Wang, Mountain View, CA (US); Yuan Xue, Palo Alto, CA (US)

(21) Appl. No.: 19/039,690

(22) Filed: Jan. 28, 2025

Related U.S. Application Data
(60) Provisional application No. 63/548,835, filed on Feb. 1, 2024.

(51) Int. Cl. G06N 3/082; G06N 3/045

(52) U.S. Cl. CPC G06N 3/082; G06N 3/045

(57) ABSTRACT

Methods, systems, and apparatus, including computer programs encoded on computer storage media, for training a neural network. One of the methods includes obtaining data specifying a trained neural network that includes a plurality of layers that include a particular layer; generating an adapted neural network, comprising generating, for the particular layer, an approximation of an adapter parameter matrix that includes fewer parameters than the adapter parameter matrix; and training the adapted neural network on a machine learning task, wherein the adapting comprises learning fine-tuned values of parameters of the approximation using training data while holding the trained values in the base parameter matrix fixed.

### CROSS-REFERENCE TO RELATED APPLICATION

This application claims priority to U.S. Provisional Application No. 63/548,835, filed on Feb. 1, 2024. The disclosure of the prior application is considered part of and is incorporated by reference in the disclosure of this application.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains a neural network to perform one or more machine learning tasks on a network input.

Particular embodiments of the subject matter described in this specification can be implemented so as to realize one or more of the following advantages.

A trained neural network, e.g., a pre-trained neural network, can be adapted to any of a variety of machine learning tasks by adding an adapter parameter matrix to each of one or more layers of the trained neural network, and then learning the fine-tuned values of the adapter parameter matrices using training data. By replacing each adapter parameter matrix with an approximation that includes multiple smaller, low-rank matrices and a smaller matrix block that is repeated multiple times to collectively represent the adapter parameter matrix, and thus includes fewer parameters than the adapter parameter matrix, the techniques described in this specification allow both the adaptation of the trained neural network and the deployment of the adapted neural network to become much more computational resource efficient. The techniques also improve the learning speed during the adaptation process.

Adapting the trained neural network to a machine learning task may therefore require fewer computational resources, e.g., reduced processor cycles, reduced wall clock time, reduced power consumption, and the computational efficiency of training is therefore improved. In some examples, an adapter parameter matrix may have as many as n² learnable parameters, while the approximation has about 2ns+b² learnable parameters (where s and b are tunable parameters, and s and b can each an order of magnitude, or more, smaller than n). The total number of arithmetic operations that would be required during the adaptation process thus reduces from Θ(n²) to Θ(ns+nb).

By generating an approximation that includes multiple low-rank dense matrices and a dense matrix block that collectively represent the larger adapter parameter matrix, the approximation technique described in this specification is tailored for execution on hardware accelerators that specialize in dense matrix multiplications, e.g., GPUs, FGPAs, and ASICs, including TPUs. In particular, the improvement in computational resource efficiency can be especially significant when the arithmetic operations involving these low-rank dense matrices and the dense matrix block are executed on the hardware accelerators. Fine-tuning a neural network by learning values of low-rank dense matrices and the dense matrix block makes the fine-tuning stage more suitable for execution by these hardware accelerators because hardware utilization rate and, in turn, hardware efficiency can be improved relative to learning values of sparse matrices.

With the reduction in parameter numbers, the memory footprint of the adapted neural network when deployed for performing the machine learning task will be reduced. Moreover, both the runtime latency and resource, e.g., memory and processing power, consumption will be reduced when computing an inference using the adapted neural network.

In addition, the final performance of the adapted neural network may also be improved because of the high expressiveness (e.g., capability of fitting into a data distribution of the machine learning task) of the approximation due to its full rank structure. Once adapted, the neural network can exceed the performance of a neural network that has been adapted using existing parameter-efficient adaptation methods on any of the machine learning tasks, including on translation, summarization, and reasoning tasks, despite an adaptation process that consumes fewer computing resources, is faster in terms of wall clock time, or both.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system.

FIG. 2 is an example illustration of operations performed a training system to generate an approximation of an adapter parameter matrix.

FIG. 3 is an example illustration of operations performed by an inference system.

FIG. 4 is a flow diagram of an example process for using an adapted neural network to perform a machine learning task on an input to generate an output.

FIG. 5 is a flow diagram of an example process for training an adapted neural network.

FIG. 6 shows a quantitative example of the performance gains that can be achieved by the approximation technique described in this specification compared to existing approximation techniques.

Like reference numbers and designations in the various drawings indicate like elements.

### DETAILED DESCRIPTION

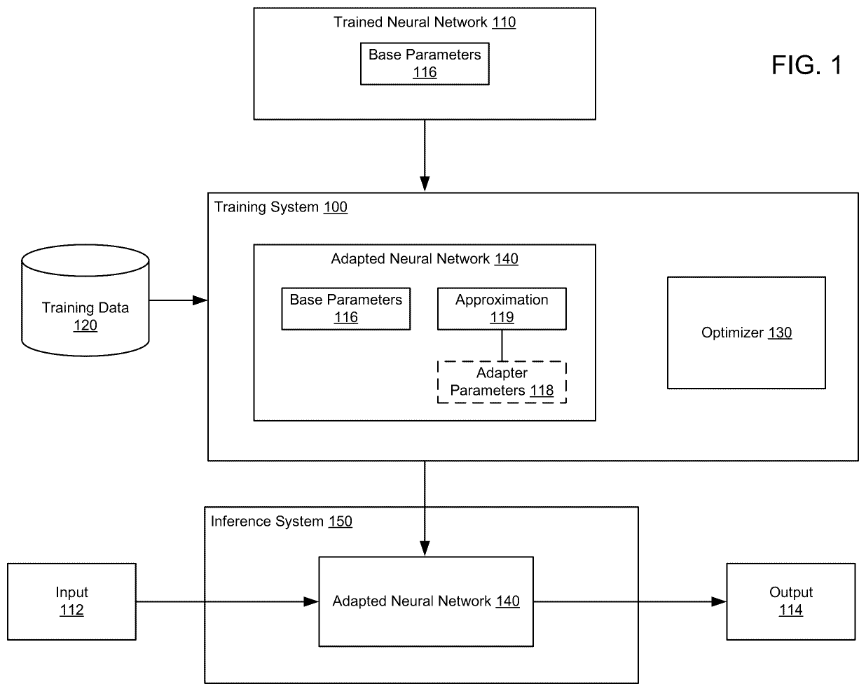

FIG. 1 shows an example training system 100. The training system 100 is an example of a system implemented as computer programs on one or more computers in one or more locations, in which the systems, components, and techniques described below can be implemented.

The training system 100 trains an adapted neural network 140 to perform one or more machine learning tasks on training data 120. The adapted neural network 140 can be trained to perform any kind of machine learning task, i.e., can be configured to receive any kind of digital data input and to generate any kind of digital data output based on the input.

In some implementations, the adapted neural network 140 can be a generative neural network that can be configured through training to perform a generative task to generate, as output, data that includes, for example, text data, image data, video data, audio data, or multimodal data that includes data in two or more different modalities.

In some of these implementations, the adapted neural network 140 can be configured as, or include, a generative (large) language model, a foundation model, or a multi-modal model, e.g., a visual and language model.

In some implementations, the adapted neural network 140 can be an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the adapted neural network 140 can be an auto-regressive Transformer-based neural network that includes (i) a plurality of attention blocks that each apply a self-attention operation and (ii) an output subnetwork that processes an output of the last attention block to generate the score distribution.

A neural network block refers to a group of one or more neural network layers in a neural network. For example, an attention block can include an attention layer and, optionally, a feed-forward layer and possibly other layers, e.g., residue connection layers, normalization layers, and so forth.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

The output block can generate an output of the adapted neural network 140. For example, the output can include a score distribution, e.g., a probability distribution, over tokens in a vocabulary of tokens. The score distribution assigns a respective score, e.g., a respective probability, to each token in the vocabulary of tokens.

The vocabulary of tokens can include any of a variety of tokens that represent text symbols or other symbols. For example, the vocabulary of tokens can include one or more of: characters, sub-words, words, punctuation marks, numbers, or other symbols that appear in a corpus of natural language text and/or computer code.

Additionally or alternatively, the vocabulary of tokens can include tokens that can represent data other than text. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

In this example, the adapted neural network 140 can have any of a variety of Transformer-based neural network architectures. Examples of such Transformer-based neural network architectures include those described in Colin Raffel, et al., Exploring the limits of transfer learning with a unified text-to-text transformer. arXiv preprint arXiv: 1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv: 2204.02311; Rohan Anil, et al. Palm 2 technical report. arXiv preprint arXiv: 2305.10403, 2023; and Gemini Team, et al., Gemini: a family of highly capable multimodal models. arXiv preprint arXiv: 2312.11805 (2023).

In some implementations, the adapted neural network 140 can be a non-auto-regressive Transformer neural network that similarly includes a plurality of attention blocks that each apply a self-attention operation, but generates an output sequence of tokens in a non-auto-regressive manner, i.e., simultaneously generates multiple tokens during each single forward pass.

Examples of such architectures in these cases include those described in Gu, J., Bradbury, J., Xiong, C., Li, V. O. K., and Socher, R. Non-autoregressive neural machine translation. In 6th International Conference on Learning Representations, ICLR 2018; Gu, J., Wang, C., and Zhao, J. Levenshtein transformer. In Wallach, H. M., Larochelle, H., Beygelzimer, A., d'Alche-Buc, F., Fox, E. B., and Garnett, R. (eds.), Advances in Neural Information Processing Systems 32: Annual Conference on Neural Information Processing Systems 2019, NeurIPS 2019; and Gu, J. and Kong, X. Fully non-autoregressive neural machine translation: Tricks of the trade. In Zong, C., Xia, F., Li, W., and Navigli, R. (eds.), Findings of the Association for Computational Linguistics: ACL/IJCNLP 2021.

In some implementations, the adapted neural network 140 can be a diffusion neural network that similarly includes a plurality of attention blocks that each apply a self-attention operation, and that generates an output data item, e.g., conditioned on a conditioning input, across multiple updating iterations by performing a reverse diffusion process. For example, the output data item can include text data, audio data, image data, or video data.

Examples of such architectures in these cases include those described in Saharia, Chitwan, et al. “Photorealistic text-to-image diffusion models with deep language understanding.” Advances in Neural Information Processing Systems 35 (2022): 36479-36494; Jonathan Ho, Ajay Jain, and Pieter Abbeel. Denoising Diffusion Probabilistic Models. arXiv: 2006.11239, 2020; and Yang Song and Stefano Ermon. Generative Modeling by Estimating Gradients of the Data Distribution. NeurIPS, 2019.

Some examples of machine learning tasks, including generative tasks, that the adapted neural network 140 when implemented using one of the architectures described above or other known architectures can be configured to perform follow.

In some cases, the neural network is a neural network that is configured to perform an image processing task, i.e., receive an input image and to process the input image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some cases, the neural network is a neural network that is configured to perform an image generation task, where the input is a conditioning input that includes, e.g., text or image or both, and the output is a sequence of intensity value inputs for the pixels of an image.

As one example, the task may be a neural machine translation task. For example, if the input to the neural network is a sequence of text, e.g., a sequence of words, phrases, characters, or word pieces, in one language, the output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example the input tokens may represent words, wordpieces or characters in a first natural language and the output tokens may represent instructions in a computer programming or markup language, or instructions for controlling an application program to perform a task e.g. build a data item such as an image or web page.

As another example, the task may be an audio processing task. For example, if the input to the neural network is a sequence representing a spoken utterance, the output generated by the neural network may be a score for each of a set of pieces of text, each score representing an estimated likelihood that the piece of text is the correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can be a classification of the spoken utterance into one of a plurality of categories, for example an identity of the natural language in which the utterance was spoken. In some cases, the neural network is a neural network that is configured to perform an audio generation task, where the input is a conditioning input that includes, e.g., text or audio or both, and the output includes a sequence of audio samples.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

In some implementations the input sequence represents data to be compressed, e.g. image data, text data, audio data, or any other type of data; and the output sequence a compressed version of the data. The input and output tokens may each comprise any representation of the data to be compressed/compressed data e.g. symbols or embeddings generated/decoded by a respective neural network.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the neural network may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the neural network, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv: 2209.14375) or Chinchilla (Hoffmann et al. arXiv: 2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example, detection or classification of an object or event may be improved when data of multiple different types (modalities) is processed. As another example, the quality (e.g., accuracy, fidelity, or intelligibility) of a generated image, video, or audio may be improved when data of multiple different types (modalities) is processed.

Prior to training the adapted neural network 140, the training system 100 obtains data specifying a trained neural network 110. For example, the data specifying the trained neural network 110 can include data specifying the trained values of the base parameters 116 of the trained neural network 110 and, optionally, the data specifying the architecture of the trained neural network 110.

For example, the base parameters 116 of the trained neural network 110 can include weights and, optionally, biases of the layers of the trained neural network 110. Much like the adapted neural network 140, the trained neural network 110 can have any neural network architecture, e.g., one of the example generative neural network architectures mentioned above.

The trained neural network 110 can have been pre-trained, by the training system 100 or a separate training system, on training data that includes a large unsupervised dataset, and thus the training system 100 can obtain data specifying the trained neural network 110 either from a local storage device of the training system 100 or from a remote storage device that is physically remote from the training system 100.

For example, the trained neural network 110 can have been pre-trained on a next token prediction task, e.g., a task that requires predicting, given a current sequence of tokens, the next token that follows the current sequence in the training data. As a particular example, the trained neural network 110 can have been pre-trained on a maximum-likelihood objective on a large dataset of text in one or more natural languages, e.g., text that is publicly available from the Internet or another text corpus, a large dataset of computer code in one or more programming languages, e.g., Python, C++, C#, Java, Ruby, PHP, and so on, e.g., computer code that is publicly available from the Internet or another code repository, a large dataset of audio samples, e.g., audio recordings or waveforms that represent the audio recordings, a large dataset of images where each image includes an array of pixels, a large dataset of videos where each video includes a temporal sequence of frames, or a large multi-modal dataset that includes a combination of two or more of these datasets.

Optionally, in some implementations, the pre-training of the trained neural network 110 also involves supervised fine-tuning (SFT) to train the trained neural network 110 on specific machine learning tasks, e.g., one or more of the tasks mentioned above, using labeled training data on a supervised training objective.

The adapted neural network 140 could be generated by adding adapter parameters 118 to the trained neural network 110 and then training, e.g., fine-tuning or adapting, the adapted neural network 140 using training data 120 to learn the trained, e.g., fine-tuned, values of the adapter parameters 118 that have been added to the adapted neural network 140.

The adapter parameters 118 are newly added parameters of the adapted neural network 140 that will be used in addition to the base parameters 116 when performing one or more machine learning tasks.

For example, the training system 100 can add, to each of one or more layers of the trained neural network 110, a respective set of adapter parameters. In this example, the adapted neural network 140 will include at least some layers that each include a respective set of base parameters that have been learned during the pre-training stage, and a respective set of adapter parameters that are not learned during the pre-training stage, and are rather learned after the pre-training stage, i.e., during fine-tuning (or adaptation) stage.

As another example, the training system 100 can add, to the trained neural network 110, one or more new layers that each include a respective set of adapter parameters. In this example, the adapted neural network 140 will include at least some new layers that were not included in the trained neural network 110, and that each include a respective set of adapter parameters that are not learned during the pre-training stage.

Adapting the trained neural network 110 to a machine learning task could involve adding, to (an instance of) the trained neural network 110, corresponding adapter parameters 118 that are specific to the machine learning task, and subsequently learning fine-tuned values of the corresponding adapter parameters 118 that are specific to the machine learning task.

To reduce the total number of trainable parameters and therefore preserve computational resource consumption of the fine-tuning stage and, after the fine-tuning stage, i.e., during inference time, the training system 100 uses an approximation technique as will be described further below.

For each of one or more layers of the adapted neural network 140, applying the approximation technique involves breaking up an original matrix containing the respective set of adapter parameters to be learned into a product of multiple smaller matrices that, when combined together through multiplication, can approximately recover the respective set of adapter parameters.

Each smaller matrix contains much fewer parameters than the original matrix. Stated differently, utilizing the approximation technique, the adapter parameters 118 that would be added as additional parameters to the adapted neural network 140 are represented (or approximated) by an approximation of the respective set of adapter parameters of each of one or more layers of the adapted neural network 140. Each approximation includes a much smaller number of parameters, i.e., relative to the respective set of adapter parameters, that would actually need to be learned during the fine-tuning stage.

Because the number of newly added parameters that needs to be learned is therefore reduced, computing resources which would be spent on neural network training or training data collection can be conserved, thereby reducing the consumption of computational resources such as processor usage, memory usage, and/or network bandwidth.

The savings in computational resources during the fine-tuning of the adapted neural network 140 can be especially significant for complex neural networks that are harder to train or for training neural networks to perform generative tasks. Moreover, the described approximation technique facilitates the adaptation of the trained neural network 110 to a larger number of machine learning tasks by making it more practical to repeatedly learning and storing corresponding adapter parameters 118 that are specific to each of the large number of machine learning tasks.

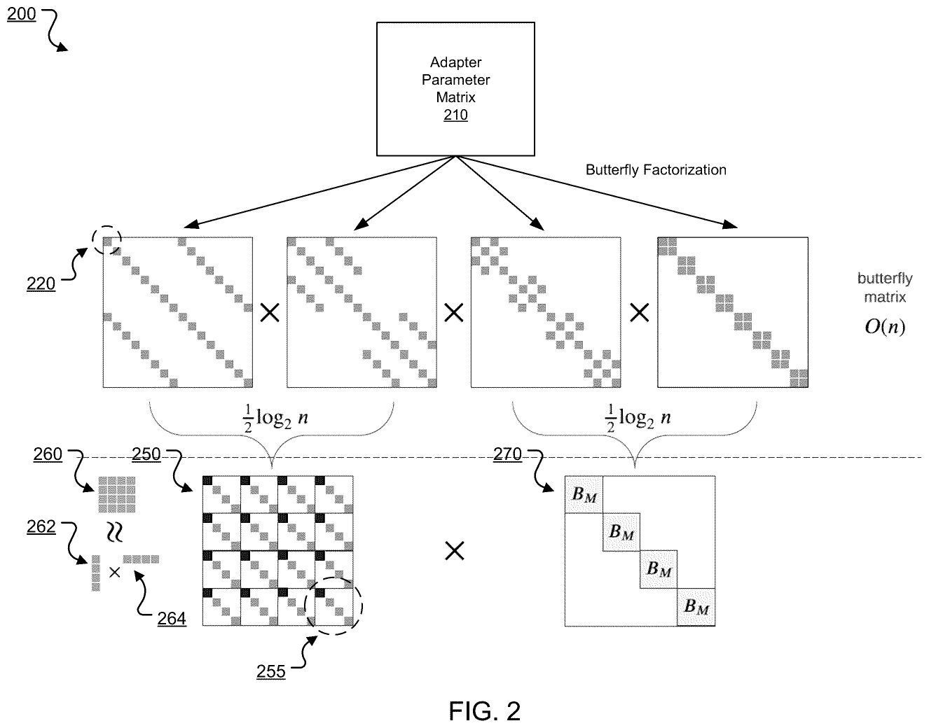

FIG. 2 is an example illustration 200 of operations performed the training system 100 to generate an approximation of an adapter parameter matrix for a particular layer of a neural network, e.g., the adapted neural network 140 of FIG. 1, that includes a plurality of layers.

The particular layer can be any layer in the plurality of layers of the neural network. For example, when configured to have a Transformer neural network architecture, the particular layer can be an attention layer or a feed-forward layer included in the Transformer neural network architecture.

The particular layer includes a set of base parameters and a set of adapter parameters. The set of base parameters include parameters that have been learned during the pre-training stage, i.e., during the training of the trained neural network 110. The set of base parameters can be arranged in a base parameter matrix that includes a plurality of matrix elements where each element represents a corresponding parameter in the set of base parameters.

The set of adapter parameters include newly added parameters that were not learned during the pre-training. Instead, the set of adapter parameters are learned during fine-tuning stage, i.e., during the training of the adapted neural network 140. Much like the set of base parameters, the set of adapter parameters can be arranged in an adapter parameter matrix 210 that includes a plurality of matrix elements where each element represents a corresponding parameter in the set of adapter parameters.

For example, in FIG. 2, the adapter parameter matrix 210 can have a dimension of p×q where p and q are positive integers. The adapter parameter matrix 210 can represent at least an additional set of weights of the particular layer that is specific to a machine learning task.

The training system 100 generates a plurality of butterfly factors from the adapter parameter matrix 210. The plurality of butterfly factors are illustrated as small squares in FIG. 2. For example, in FIG. 2, the dashed circle 220 encompasses one of the plurality of butterfly factors.

Example butterfly factorization algorithms that can be used by the training system 100 to generate the plurality of butterfly factors include those described in Parker, D. S. Random butterfly transformations with applications in computational linear algebra. 1995 and Dao, T., Gu, A., Eichhorn, M., Rudra, A., and Re, C. Learning fast algorithms for linear transforms using butterfly factorizations. In International Conference on Machine Learning (ICML), 2019.

Each butterfly factor B_{k,k} is a matrix of size k that is in the form of:

$$( \begin{matrix}{D}_{1} & {D}_{2} \\ {D}_{3} & {D}_{4}\end{matrix} ) ,$$

$$( \frac{k}{2} , \frac{k}{2} ) ,$$

where Dᵢ is a diagonal matrix of size where k is a positive integer. A diagonal matrix is a matrix in which the elements outside the main diagonal are all zero. Elements of the main diagonal can either be zero or nonzero.

The product of all of the plurality of butterfly factors is called a butterfly factor matrix (or “butterfly matrix” for short). A butterfly matrix is a block-diagonal matrix of size n (which is a positive integer) and block size k that is in the form of:

$${B}_{n , k} = diag ( {\underbrace{{B}_{k , k} , {B}_{k , k} , … , {B}_{k , k}}}_{{B}_{k , k} is repeated for n / k times .} )$$

When n is a power of 2, a butterfly matrix of size n can then be represented using the above notations as:

$${ℬ}_{n} = {\underbrace{{B}_{n , n} \times {B}_{n , \frac{n}{2}} \times … \times {B}_{n , 2}}}_{log n factors}$$

The training system 100 splits the butterfly matrix into two halves: a first half that includes a first subset of the plurality of butterfly factors and a second half that includes a second subset of the plurality of butterfly factors. The first and second subsets are non-overlapping subsets of the plurality of butterfly factors that have been generated from the adapter parameter matrix 210.

For example, the training system 100 can split the butterfly matrix into two halves, where each half includes

$$\frac{1}{2} log log n$$

butterfly factors, which are represented as:

$$\begin{matrix}{ℬ}_{n} = {\underbrace{{B}_{n , n} \times … \times {B}_{n , 2 \sqrt{n}}}}_{\frac{1}{2} log n factors} \times {\underbrace{{B}_{n , \sqrt{n}} \times … \times {B}_{n , 2}}}_{\frac{1}{2} log n factors} \\ = D \times B\end{matrix}$$

The training system 100 generates a first matrix 250 as a product determined by multiplying the first subset of the plurality of butterfly factors together. The first matrix 250 can correspond to matrix D in the equation above. When the first subset of the plurality of butterfly factors are multiplied together, the training system 100 can generate, as the product of the first subset of the plurality of butterfly factors, the first matrix 250 that is in the form of:

$$D = ( \begin{matrix}{D}_{1 , 1} & {D}_{1 , 2} & … & {D}_{1 , n / b} \\ {D}_{2 , 1} & {D}_{2 , 2} & … & {D}_{2 , n / b} \\ & & … & \\ {D}_{n / b , 1} & {D}_{n / b , 2} & … & {D}_{n / b , n / b}\end{matrix} )$$

where each D_{i,j}∈R^{b×b}, i,j∈[1, . . . , n/b] is a diagonal matrix block of size (b,b). b can be any positive integer that is no greater than n. For example, b=\sqrt{n}.

The first matrix 250 includes a plurality of diagonal matrix blocks. Each diagonal matrix block includes a respective plurality of diagonal elements. Much like the butterfly factors, the diagonal elements are illustrated as small squares in matrix 250 in FIG. 2. For example, in FIG. 2, a dashed circle 255 encompasses one of the plurality of diagonal matrix blocks. The diagonal matrix block that is encompassed by the dashed circle 255 includes a total of four diagonal elements (illustrated as four small squares).

The training system 100 generates a plurality of matrix blocks from the first matrix 250. Each matrix block can have any shape. In some cases, each matrix block is a square matrix that has a same number of elements along the horizontal dimension and along the vertical dimension. In some other cases, each matrix block is a rectangular matrix that has different numbers of elements along the horizontal dimension and along the vertical dimension. In yet other cases, some of the matrix blocks in the plurality of matrix blocks are square matrices, while others of the matrix blocks in the plurality of matrix blocks are rectangular matrices.

Each matrix block includes one or more respective diagonal elements from each of the plurality of diagonal matrix blocks. For example, a matrix block can include the top left (namely, the first) diagonal element from each of the plurality of diagonal matrix blocks. As another example, a matrix block can include the bottom right (namely, the last) diagonal element from each of the plurality of diagonal matrix blocks.

For example, in FIG. 2, the matrix block 260 includes the top left diagonal element (illustrated as the small square in darker color) from the total of four diagonal elements in the diagonal matrix block that is encompassed by the dashed circle 255, among the top left diagonal element from each of the other diagonal matrix blocks in the plurality of diagonal matrix blocks.

By doing so, the training system 100 generates a reformulated first matrix (matrix D′) that is in the form of:

$${\tilde{D}}^{k} = ( \begin{matrix}{D}_{1 , 1}^{k} & {D}_{1 , 2}^{k} & … & {D}_{1 , n / b}^{k} \\ {D}_{2 , 1}^{k} & {D}_{2 , 2}^{k} & … & {D}_{2 , n / b}^{k} \\ & & … & \\ {D}_{n / b , 1}^{k} & {D}_{n / b , 2}^{k} & … & {D}_{n / b , n / b}^{k}\end{matrix} ) ∈ {ℝ}^{\frac{n}{b} \times \frac{n}{b}}$$

where D_{i,j}^{k} is the k-th diagonal element of D_{i,j} where k∈[1, . . . , b].

For example, in FIG. 2, the matrix block 260 can represent the matrix \tilde{D}¹ which is formed by selecting the top left (namely, the first) diagonal elements from each of the plurality of diagonal matrix blocks D_{i,j}.

For each of the plurality of matrix blocks, the training system 100 performs a low-rank factorization to factorize the matrix block into a first rank-s matrix and a second rank-s matrix.

For example, in FIG. 2, the training system 100 performs a low-rank factorization to factorize the matrix block 260 into a first rank-s matrix 262 and a second rank-s matrix 264. A low-rank factorization is a technique that breaks down a matrix into two smaller matrices with lower dimensions. In some implementations, the training system 100 determines a value for the rank s, and then performs the low-rank factorization in accordance with the determined value for s.

A common example of how the value for the rank s can be determined is utilizing singular value decomposition (SVD) to find the best low-rank approximation of a matrix by keeping only the most significant singular values and their corresponding vectors, although the training system 100 can alternatively use other techniques, e.g., geometric mean decomposition (GMD), to determine the value for the rank s.

Generated by low-rank factorization, the first rank-s matrix 262 and the second rank-s matrix 264 are each a respective low-rank matrix. A matrix is considered low rank when the number of linearly independent rows or columns is smaller than its total number of rows and columns.

The training system 100 generates a second matrix 270 as a product determined by multiplying the second subset of the plurality of butterfly factors together. The second matrix 270 can correspond to matrix B in the equation above. When the second subset of the plurality of butterfly factors are multiplied together, the training system 100 can generate, as the product of the second subset of the plurality of butterfly factors, the second matrix 270 that is in the form of:

$$B = diag ( {\underbrace{{B}_{M} , {B}_{M} , … , {B}_{M} )}}_{{B}_{M} is repeated for n / b times .} , {B}_{M} ∈ {ℝ}^{b \times b}$$

where B_{M} is a matrix block of R^{b×b} elements. The second matrix 270 is in the form of a block diagonal matrix which includes a plurality of repetitions of the matrix block B_{M} along a main diagonal of the second matrix 270.

The training system 100 generates the approximation of the adapter parameter matrix 210 from the reformulated first matrix (which, in turn, is generated based on the first matrix 250) and the second matrix 270. The training system 100 can generate the approximation of the adapter parameter matrix 210 by combining the parameters of the approximation through multiplication.

In particular, the parameters of the approximation include, for each of the plurality of matrix blocks that has been generated from the first matrix 250, parameters in the first rank-s matrix and parameters in the second rank-s matrix. In addition, the parameters of the approximation include parameters in the matrix block in the second matrix 270. In this manner, the approximation includes fewer parameters than the adapter parameter matrix 210.

In principle, the training system 100 can repeatedly perform the operations described above with reference to FIG. 2 for each of one or more layers of the adapted neural network 140 to generate an approximation of the respective set of adapter parameters added to the layer.

By doing so, the training system 100 can generate an adapted neural network 140 that includes the base parameters 116 of the trained neural network 110 and the adapter parameters 118, where the adapter parameters 118 are represented (or approximated) by the approximation of the respective set of adapter parameters of each of one or more layers of the trained neural network 110.

Turning back to FIG. 1, having generated the adapted neural network 140 based on the trained neural network 110 using the approximation technique, the training system 100 then trains, e.g., fine-tunes or adapts, the adapted neural network 140 using training data 120 to learn the trained, e.g., fine-tuned, values of the parameters of the approximation of the adapter parameters 118 that would be added as additional parameters to the adapted neural network 140, thereby adapting the adapted neural network 140 to perform a machine learning task.

In some implementations, the trained neural network 110 can have been pre-trained on a next token prediction task, and the training system 100 can adapt the adapted neural network 140 to perform any one of the machine learning tasks, including generative tasks, mentioned above.

In some implementations, the trained neural network 110 can have been pre-trained on a machine learning task, and the training system 100 can adapt the adapted neural network 140 to perform the same or similar machine learning task in different deployment environments, different applications, different use cases, and so forth.

For example, the trained neural network 110 can have been pre-trained to perform a generative task to generate, as output, data that includes, for example, text data, image data, video data, audio data, or multimodal data that includes data in two or more different modalities, in a first use case. The training system 100 can adapt the adapted neural network 140 to perform the same generative task to generate data in the same modality (ies), but in a second use case that is different from the first use case.

For example, the first use case may be a chatbot use case while the second use case may be a computer code generation use case. As another example, the first use case may be a sketch image generation use case while the second use case may be a photorealistic image generation use case.

The training system 100 trains the adapted neural network 140 on training data 120 to repeatedly update the values of the parameters of the approximation 119 of the adapter parameters 118 that would be added as additional parameters to the adapted neural network 140, i.e., to generate trained values of parameters from initial values.

The training data 120 includes multiple training examples which, in turn, each include a training input and a corresponding target output for the training input for the machine learning task, i.e., a target output to be generated by the adapted neural network 140 by processing the training input.

Generally, the training system 100 trains the adapted neural network 140 to minimize an objective function for the machine learning task.

The objective function can be any appropriate objective function for the machine learning task. Generally, however, the objective function includes one or more terms that measure, for each training input, the quality of a training output for the training input generated by performing a forward pass through (i) the base parameters 116 and (ii) the parameters of the approximation 119 of the adapter parameters 118 of the adapted neural network 140, e.g., relative to a respective target output for the training input.

For example, the one or more terms can be cross entropy loss terms, mean squared error loss terms, negative log likelihood loss terms, and so on. The objective function can also include other terms, e.g., regularization terms, auxiliary loss terms, unsupervised learning loss terms, and so on, that do not depend on the target outputs for the training inputs.

More specifically, the training system 100 performs the training over a plurality of update iterations. At each update iteration, the training system 100 updates at least some of the parameters using a plurality of training examples (a “batch” or a “mini-batch” of training examples) sampled from the training data 120.

Thus, by repeatedly performing update iterations, the training system 100 repeatedly updates the values of at least some of the parameters of the adapted neural network 140 to determine trained values of at least some of the parameters that will cause the adapted neural network 140 to perform well on the machine learning task.

More specifically, at each update iteration, the training system 100 computes, using the plurality of training examples, a gradient of the objective function for the machine learning task with respect to each of the parameters of the adapted neural network 140.

The training system 100 then uses an optimizer 130 to determine an update to the values of at least some of the parameters from the gradients. The optimizer 130 can be an optimizer that uses any of a variety of known update rules, e.g., an Adam update rule, a RMSProp update rule, an Adafactor update rule, a stochastic gradient descent update rule, and so forth.

In some implementations, the training system 100 only updates the values of the parameters of the approximation 119 of the adapter parameters 118 of the adapted neural network 140, while holding the base parameters 116 fixed to their trained values which have been learned at a result of the pre-training stage.

For example, in FIG. 2, the training system 100 may not update the base parameter matrix for each of the one or more layers of the adapted neural network 140. Instead, the training system 100 only updates the values of the parameters of the approximation of the adapter parameter matrix 210 for each of the one or more layers of the adapted neural network 140.

After the training, the training system 100 or a different inference system 150 deploys the adapted neural network 140 on one or more computing devices to perform inference, i.e., to generate new outputs 114 for the machine learning task for new inputs 112.

To deploy the adapted neural network 140 at the inference system 150, the training system 100 can output data specifying the adapted neural network 140 to the inference system 150. In some implementations, the output data only includes data that defines the trained values of the parameters of the approximation 119 of the adapter parameters 118 of the adapted neural network 140, and excludes data that defines the trained values of the base parameters 116 of the adapted neural network 140.

For example, in FIG. 2, rather than storing the adapter parameter matrix 210 for each of the one or more layers of the adapted neural network 140, the inference system 150 need only store the approximation of the adapter parameter matrix 210 for each of the one or more layers of the adapted neural network 140, which have been received from the training system 100.

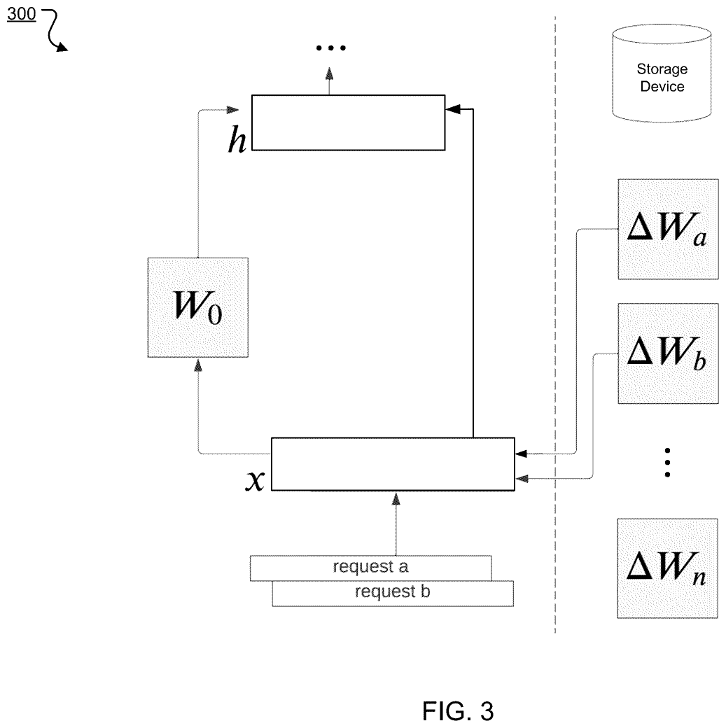

FIG. 3 is an example illustration 300 of operations performed by the inference system 150. The inference system 150 is an example of a system implemented as computer programs on one or more computers in one or more locations that can perform one or more machine learning tasks using the base parameters 116 of the adapted neural network 140 and an approximation 119 of the adapter parameters 118 of the adapted neural network 140.

In some implementations, the inference system 150 stores the base parameters 116 together with the approximation 119 of the adapter parameters 118. For example, the base parameters 116 can be stored together with the approximation 119 of the adapter parameters 118 in one or more storage devices local to the inference system 150.

In some implementations, the inference system 150 stores the base parameters 116 separate from the approximation 119 of the adapter parameters 118. For example, the approximation 119 of the adapter parameters 118 can be stored in one or more storage devices local to the inference system 150, while the base parameters 116 can be stored in one or more storage devices remote from the inference system 150.

In some implementations, as illustrated in FIG. 3, the inference system 150 stores the respective approximation 119 of each of multiple sets of adapter parameters 118 that are specific to different machine learning tasks. In other words, the inference system 150 stores, for the same set of base parameters 116 of the adapted neural network 140, respective approximations 119 of multiple sets of adapter parameters 118 that can be user together with the same set of base parameters 116 to perform different machine learning tasks.

For example, in FIG. 3, the inference system 150 can store the respective approximations ΔWₐ, ΔW_{b}, . . . , ΔWₙ of a plurality of adapter parameter matrices associated with a particular layer of the adapted neural network. At least one of the respective approximations can have been generated using the approximation technique. The respective approximations ΔWₐ, ΔW_{b}, . . . , ΔWₙ correspond to machine learning task a, machine learning task b, . . . , and machine learning task n, respectively.

In these implementations, in response to receiving a request, e.g., request a, to use the adapted neural network to generate an output for a machine learning task, e.g., machine learning task a, the inference system 150 selects, based on the request, and from the respective approximations ΔWₐ, ΔW_{b}, . . . , ΔWₙ of the plurality of adapter parameter matrices associated with the particular layer of the neural network, a selected approximation of an adapter parameter matrix, e.g., approximations ΔWₐ.

The inference system 150 then processes an input associated with the received request using (i) the base parameters, (ii) the parameters of the selected approximation of the adapter parameter matrix, and, optionally, in some implementations, (iii) the parameters of the approximation of the adapter parameter matrix associated with each of one or more other layers of the adapted neural network that can be selected in a similar manner, to generate the output for the machine learning task.

The way in which the inference system 150 makes use of the parameters of the selected approximation of the adapter parameter matrix is different from the way in which the inference system 150 would make use of the adapter parameters represented by the adapter parameter matrix.

When using the adapter parameter matrix and rather than its approximation to perform the machine learning task on the input to generate the output, the adapter parameter matrix associated with the particular layer would be added to the base parameter matrix associated with the particular layer and then multiplied to a layer input of the particular layer to generate a layer output of the particular layer.

For example, a particular layer, e.g., an attention layer or a feed-forward layer, in a particular neural network, e.g., a Transformer neural network, can be associated with a base parameter matrix that is in the form of:

W₀∈R^{n×n}

In this example, the particular layer after a fine-tuning stage performed without the approximation technique could be associated with a new parameter matrix in the form of:

$${W}^{′} = {W}_{0} + Δ \tilde{W}$$

where Δ\tilde{W} represents the adapter parameter matrix that has values learned during the fine-tuning stage, e.g., by holding the learned values of the trained parameter matrix W₀ fixed and updating Δ\tilde{W} using the training data.

Continuing with this example, during each forward process through the layers of the particular neural network, assume x, h∈Rⁿ are the input/output of the particular layer, respectively, then:

$$h = {W}^{′} x = {W}_{0} x + Δ \tilde{W} x .$$

In other words, the output of the particular layer can be computed as a sum of (i) a first product between the base parameter matrix and the layer input and (ii) a second product between the adapter parameter matrix and the layer input. Put another way, the output can be computed as a product between (i) the layer input and (ii) a sum of the base parameter matrix and the adapter parameter matrix.

This is different from how the approximation of the adapter parameter matrix can be used by the inference system 100 to perform the machine learning task on the input to generate the output, as discussed below.

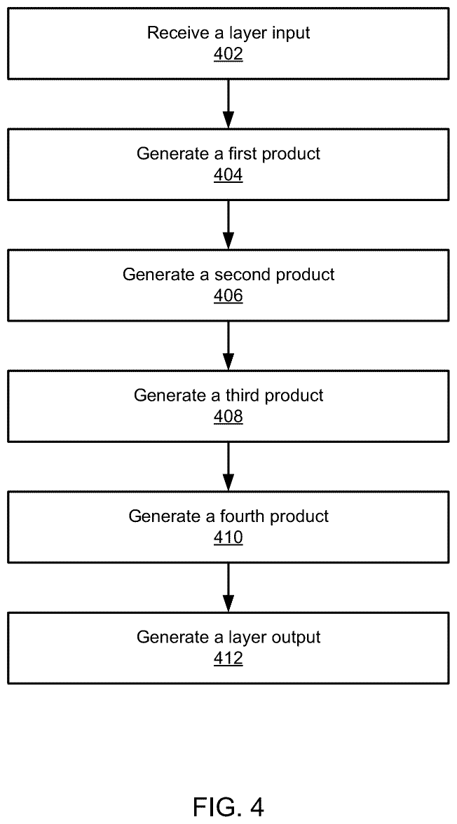

FIG. 4 is a flow diagram of an example process 400 for using an adapted neural network to perform a machine learning task on an input to generate an output. For convenience, the process 400 will be described as being performed by a system of one or more computers located in one or more locations. For example, an inference system, e.g., the inference system 150 of FIG. 1, appropriately programmed, can perform the process 400.

The system receives a layer input of a particular layer of an adapted neural network (step 402). For example, the adapted neural network can be a Transformer neural network, and the particular layer can be an attention layer or a feed-forward layer in the Transformer neural network.

In general, the layer input is derived from the input of the machine learning task the during a forward pass through the layers of the adapted neural network. For example, the layer input can be an embedded representation of the input received by the adapted neural network, an embedded representation of the already generated portion of the output, or the layer output generated by the preceding layer in the adapted neural network, depending on the configuration of the adapted neural network and the position of the particular layer within the adapted neural network. As a specific example, the layer input can be an embedded representation of a token in an input sequence that is being processed by the adapted neural network for the machine learning task.

In particular, the particular layer is associated with a base parameter matrix and an approximation of an adapter parameter matrix. A plurality of butterfly factors can be generated from the adapter parameter matrix. A first matrix can be determined by multiplying a first subset of the plurality of butterfly factors together. A second matrix can be determined by multiplying a second subset of the plurality of butterfly factors together.

The parameters of the approximation include, for each of a plurality of matrix blocks that has been generated from the first matrix, parameters in a first rank-s matrix and parameters in a second rank-s matrix. In addition, the parameters of the approximation include parameters in the matrix block in the second matrix.

The system generates a first product by multiplying the layer input and the first rank-s matrix of each of the plurality of matrix blocks that has been generated from the first matrix (step 404). In some implementations, the system can generate the first product by performing a first batch matrix multiplication operation.

Batch multiplication involves performing matrix multiplication over a batch of matrices. By performing the first batch matrix multiplication operation, the system can more quickly and more computationally efficiently multiply the layer input and the first rank-s matrix of each of the plurality of matrix blocks to generate the first product.

The system generates a second product by multiplying the first product and the second rank-s matrix of each of the plurality of matrix blocks (step 406). In some implementations, the system can generate the second product by performing a second batch matrix multiplication operation to multiply the first product and the second rank-s matrix of each of the plurality of matrix blocks to generate the second product.

The system generates a third product by multiplying the second product and the second matrix (step 408). In some implementations, the system can generate the third product by performing a third batch matrix multiplication operation to multiply the second product and the second matrix to generate the third product.

In some implementations, the system can perform the first, second, and third batch matrix multiplication operations as a sequence of serialized operations, i.e., one after another in a sequence.

The system generates a fourth product by multiplying the layer input and base parameter matrix (step 410). In some implementations, the system can generate the fourth product by performing a fourth batch matrix multiplication operation to multiply the layer input and the base parameter matrix to generate the fourth product.

The system generates the layer output of the particular layer by computing a sum of the third product and the fourth product (step 412). That is, the system generates the layer output of the particular layer by adding the third product and the fourth product together.

For each of one or more of the layers included in the adapted neural network, the system can repeatedly (i.e., at each of the one or more of the layers included in the adapted neural network) perform the process 400 to generate a layer output of the layer based on a layer input of the layer.

By repeatedly performing the process 400 for at least some of the layers in the adapted neural network and then by processing at least part of the layer output generated by the last layer that is arranged preceding to the output subnetwork in the adapted neural network using one or more output layers, the system can generate the output for the machine learning task based on the input.

That is, the process 400 can be performed as part of predicting an output for an input for which the desired output, i.e., the output that should be generated by the system for the input, is not known.

The process 400 can also be performed as part of processing inputs derived from a set of training data, i.e., inputs derived from a set of inputs for which the output that should be generated by the system is known, in order to train the adapted neural network to determine the trained values of at least some of the parameters of the adapted neural network.

As discussed below, a training system, e.g., the training system 100 of FIG. 1, can repeatedly perform the process 400 on inputs selected from the training data during the fine-tuning stage as part of the plurality of update iterations to update the values of the parameters of the approximation of the adapter parameters of the adapted neural network based on optimizing an objective function that is appropriate for the machine learning task that the adapted neural network is configured to perform.

In some implementations, the operations, e.g., the first, second, and third batch matrix multiplication operations, involved in the pre-training stage, fine-tuning stage, or both and in the inference time of the adapted neural network are executed on a set of hardware accelerators.

Hardware accelerators are computing devices having specialized hardware configured to perform specialized computations including, e.g., dense matrix multiplications. Examples of accelerators include graphics processing units (“GPUs”), field-programmable gate arrays (“FGPAs”), and application-specific integrated circuits (“ASICs”), including tensor processing units (“TPUs”).

In practice, each of the first rank-s matrices and the second rank-s matrices may be a dense matrix. The matrix block may also be a dense matrix. A dense matrix is a matrix with more than a threshold number of non-zero input values, e.g., more non-zero input values than zero input values.

Advantageously, in these implementations, the way the approximation technique generates the multiple smaller matrices to approximate the adapter parameter matrix makes the operations involving these smaller and yet denser matrices more suitable for computation by using hardware accelerators that are specialized for dense matrix multiplications.

Dense matrix computations improve hardware utilization rate and, in turn, hardware efficiency of the hardware accelerators, at least in part because dense matrix computations have facilitate a high degree of parallelism, meaning many calculations can be performed simultaneously at the hardware accelerator, making them ideal for exploiting the parallel processing capabilities of the hardware accelerator, unlike sparse matrices which have many zero values and require additional logic to identify non-zero values, reducing potential parallelism.

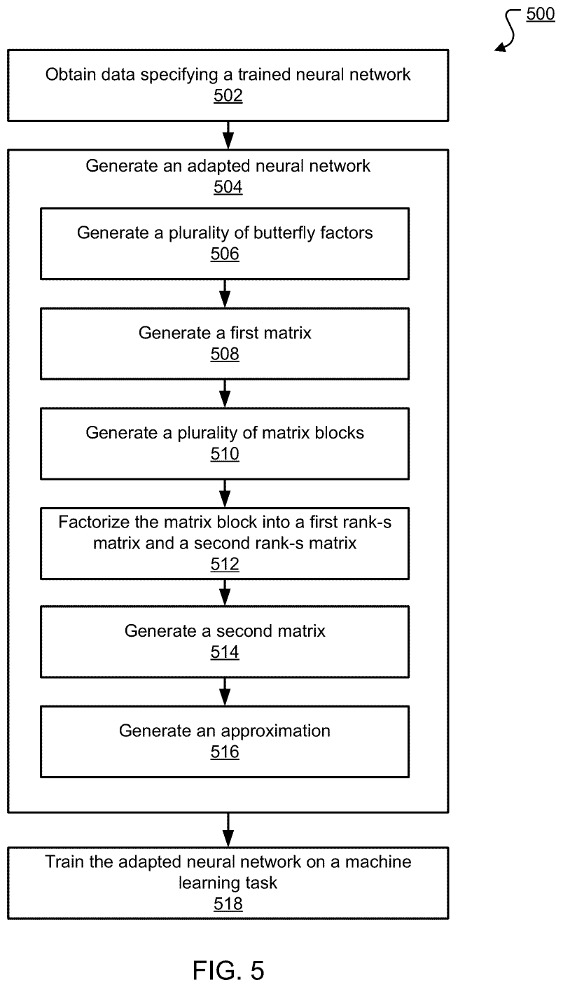

FIG. 5 is a flow diagram of an example process 500 for training an adapted neural network. For convenience, the process 500 will be described as being performed by a system of one or more computers located in one or more locations. For example, a training system, e.g., the training system 100 of FIG. 1, appropriately programmed, can perform the process 500.

The system obtains data specifying a trained neural network that includes a plurality of layers (step 502). The plurality of layers include a particular layer. For example, the trained neural network can be a Transformer neural network, and the particular layer can be an attention layer or a feed-forward layer in the Transformer neural network.

The particular layer is associated with a base parameter matrix that represents a set of base parameters of the particular layer. The set of base parameters have values that were learned during the training of the trained neural network.

The system generates an adapted neural network based on the trained neural network (step 504). As part of the generation of the adapted neural network, the system generates, for the particular layer, an approximation of an adapter parameter matrix that approximates the adapter parameter matrix. The adapter parameter matrix represents a set of adapter parameters of the particular layer. The set of adapter parameters are newly added parameters the values of which are not learned during the training of the trained neural network.

The approximation includes fewer parameters than the adapter parameter matrix. Generating the approximation involves steps 506-516. In principle, the system can repeatedly perform an iteration of steps 506-516 for each of one or more other layers in the plurality of layers of the trained neural network to generate an approximation of an adapter parameter matrix associated with the layer.

The system applies a butterfly factorization algorithm to generate a plurality of butterfly factors from the adapter parameter matrix (step 506). The plurality of butterfly factors includes a first subset and a second subset. The first and second subsets are non-overlapping subsets of the plurality of butterfly factors that have been generated from the adapter parameter matrix.

The system generates a first matrix from a product of the first subset of the plurality of butterfly factors (step 508). The first matrix includes a plurality of diagonal matrix blocks.

The system generates a plurality of matrix blocks from the first matrix (step 510). Each matrix block includes one or more respective diagonal elements from each of the plurality of diagonal matrix blocks. For example, a matrix block can include the top left diagonal element or, analogously, the bottom right diagonal element or an element at another position, from each of the plurality of diagonal matrix blocks.

For each of the plurality of matrix blocks, the system performs low-rank factorization to factorize the matrix block into a first rank-s matrix and a second rank-s matrix (step 512). Generated by low-rank factorization, the first rank-s matrix and the second rank-s matrix are each a respective low-rank matrix.

The system generates a second matrix from a product of the second subset of the plurality of butterfly factors (step 514). The second matrix includes a plurality of repetitions of a matrix block along a diagonal of the second matrix. That is, the matrix block is repeated multiple times along the diagonal of the second matrix.

The system generates the approximation from the first matrix and the second matrix (step 516). The system can generate the approximation by combining the parameters of the approximation through multiplication. In particular, the parameters of the approximation include, for each of the plurality of matrix blocks that has been generated from the first matrix, parameters in the first rank-s matrix and parameters in the second rank-s matrix. In addition, the parameters of the approximation include parameters in the matrix block in the second matrix.

The system trains the adapted neural network on a machine learning task by using training data and based on optimizing an objective function that is appropriate for the machine learning task that the adapted neural network is configured to perform (step 518).

In some implementations, the system only updates the values of the parameters of the approximation of the adapter parameter matrix for the particular layer, and, likewise, the values of the parameters of the approximation of the adapter parameter matrix for each of the one or more other layers, while holding the set of base parameters represented by the base parameter matrix fixed to their trained values which have been learned at a result of the pre-training stage.

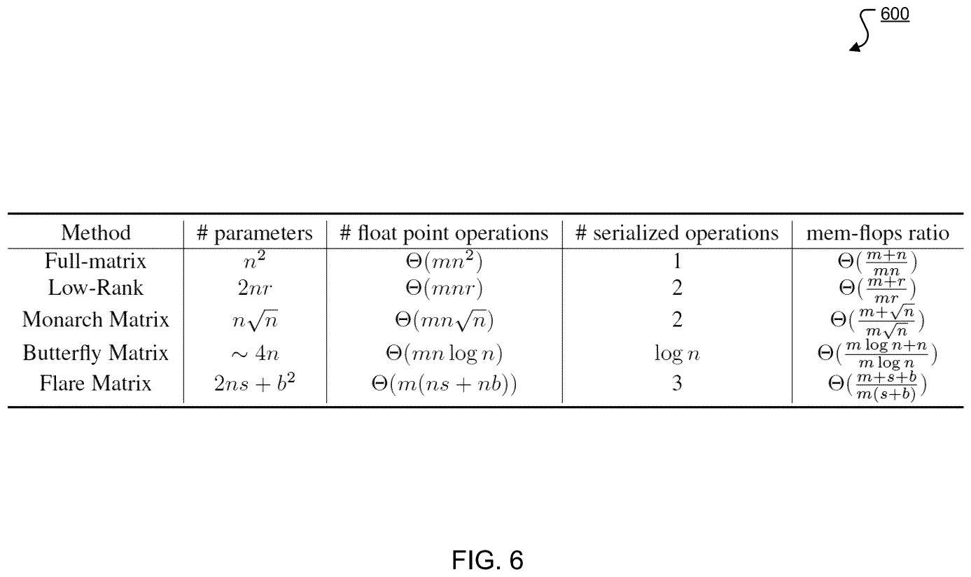

FIG. 6 shows a quantitative example of the performance gains that can be achieved by the approximation technique described in this specification compared to existing approximation techniques.

The table in FIG. 6 shows a comparison between different approximation techniques for approximating an adapter parameter matrix ΔW∈R^{n×n}. The FLOPS are computed when performing a forward pass through a neural network with inputs in the size of length n and batch size of m. The memory-flops ratio indicates the ratio of memory access to arithmetic operations.

In the table in FIG. 6, “Full-matrix” represents the case where no approximation technique is used to approximate the adapter parameter matrix. “Low Rank” represents the case where a low rank approximation technique (e.g., as described in Hu, E. J., et al. Lora: Low-rank adaptation of large language models. arXiv preprint arXiv: 2106.09685, 2021) is used to approximate the adapter parameter matrix. “Monarch Matrix” represents the case where a monarch matrix approximation technique (e.g., as described in Dao, T., et al. Monarch: Expressive structured matrices for efficient and accurate training. In International Conference on Machine Learning, pp. 4690-4721. PMLR, 2022.) is used to approximate the adapter parameter matrix. “Butterfly matrix” represents the case where a butterfly matrix approximation technique (e.g., as described in Dao, T., et al. Learning fast algorithms for linear transforms using butterfly factorizations. In International conference on machine learning, pp. 1517-1527. PMLR, 2019) is used to approximate the adapter parameter matrix. “Flare matrix” represents the case where the approximation technique described in this specification is used to approximate the adapter parameter matrix.

It will be appreciated that, compared to these existing approximation techniques, the approximation technique described in this specification achieves the best overall balance between the number of parameters, the number of float point operations, and the compute efficiency. For example, the low rank approximation technique has limited flexibility with respect to the parameter efficiency, which may limit the model performances. The Butterfly matrix approximation technique involves multiplying log(n) butterfly factors in a sequence, which might not be computationally efficient when executed on hardware accelerators that specialize in dense matrix multiplications. The Monarch matrix approximation technique requires storing and learning a much greater number of parameters.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
obtaining data specifying a trained neural network that includes a plurality of layers that include a particular layer, wherein the particular layer is associated with a base parameter matrix having trained values;
generating an adapted neural network, comprising generating, for the particular layer, an approximation of an adapter parameter matrix that includes fewer parameters than the adapter parameter matrix, wherein generating the approximation comprises:
generating, from the adapter parameter matrix, a plurality of butterfly factors;
generating, from a product of a first subset of the plurality of butterfly factors, a first matrix that comprises a plurality of diagonal matrix blocks;
generating, from the first matrix, a plurality of matrix blocks that each comprise one or more respective diagonal elements from each of the plurality of diagonal matrix blocks;
for each of the plurality of matrix blocks, performing low-rank factorization to factorize the matrix block into a first rank-s matrix and a second rank-s matrix;
generating, from a product of a second subset of the plurality of butterfly factors, a second matrix that comprises a plurality of repetitions of a matrix block along a diagonal of the second matrix; and
generating the approximation from the first matrix and the second matrix; and
training the adapted neural network on a machine learning task, wherein the adapting comprises learning fine-tuned values of parameters of the approximation using training data while holding the trained values in the base parameter matrix fixed.

2. The method of claim 1, wherein performing the low-rank factorization to factorize the matrix block into the first rank-s matrix and the second rank-s matrix comprises:
determining a value for s; and
performing the low-rank factorization in accordance with the determined value for s.

3. The method of claim 1, wherein the matrix block is a square matrix that has a same number of elements along the horizontal dimension and along the vertical dimension.

4. The method of claim 1, wherein the matrix block is a rectangular matrix that has different numbers of elements along the horizontal dimension and along the vertical dimension.

5. The method of claim 1, wherein training the adapted neural network to the machine learning task comprises, during each forward pass through the plurality of layers:
receiving a layer input for the particular layer;
generating a first product by multiplying the layer input and the first rank-s matrix of each of the plurality of matrix blocks;
generating a second product by multiplying the first product and the second rank-s matrix of each of the plurality of matrix blocks;
generating a third product by multiplying the second product and the second matrix; and
generating the layer output for the particular layer based on the third product.

6. The method of claim 5, further comprising, during each forward pass through the plurality of layers:
generating a fourth product by multiplying the layer input and base parameter matrix; and
generating the layer output for the particular layer by computing a sum of the third product and the fourth product.

7. The method of claim 5, wherein:
generating the first product comprises performing a first batch matrix multiplication operation to multiply the layer input and the first rank-s matrix of each of the plurality of matrix blocks to generate the first product;
generating the second product comprises performing a second batch matrix multiplication operation to multiply the first product and the second rank-s matrix of each of the plurality of matrix blocks to generate the second product; and
generating the third product comprises performing a third batch matrix multiplication operation to multiply the second product and the second matrix to generate the third product.

8. The method of claim 7, wherein the first, second, and third batch matrix multiplication operations are performed as a sequence of serialized operations.

9. The method of claim 6, wherein the first, second, and third batch matrix multiplication operations are performed on a set of one or more hardware accelerators that are specialized for dense matrix multiplications.

10. The method of claim 1, wherein the parameters in the approximation comprise, for each of the plurality of matrix blocks, parameters in the first rank-s matrix and parameters in the second rank-s matrix.

11. The method of claim 1, wherein the parameters in the approximation comprise parameters in the matrix block.

12. The method of claim 1, wherein the parameters in the approximation comprise both (i) parameters in the first rank-s matrix and parameters in the second rank-s matrix for each of the plurality of matrix blocks, and (ii) parameters in the matrix block.

13. The method of claim 1, wherein each butterfly factor is a matrix of size k that is in the form of
$$( \frac{{D}_{1}}{{D}_{3}} \frac{{D}_{2}}{{D}_{4}} ) ,$$
where Dᵢ is a diagonal matrix of size
$$( \frac{k}{2} , \frac{k}{2} ) ,$$
where k is a positive integer.

14. The method of claim 1, wherein the adapter parameter matrix has a dimension of p×q where p and q are positive integers, and represents at least an additional set of weights of the particular layer that is specific to the machine learning task.

15. The method of claim 14, wherein, when performing the downstream task, the adapter parameter matrix is added to the base parameter matrix and then multiplied to another layer input to generate another layer output.

16. The method of claim 1, further comprising deploying the fine-tuned neural network to perform the machine learning task, wherein the deploying comprises storing, on one or more storage devices, the approximation of the adapter parameter matrix in place of the adapter parameter matrix.

17. The method of claim 1, wherein the trained neural network has a Transformer neural network architecture, and wherein the particular layer is an attention layer or a feed-forward layer included in the Transformer neural network architecture.

18. A system comprising one or more computers and one or more storage devices storing instructions that when executed by the one or more computers cause the one more computers to perform operations comprising:
obtaining data specifying a trained neural network that includes a plurality of layers that include a particular layer, wherein the particular layer is associated with a base parameter matrix having trained values;
generating an adapted neural network, comprising generating, for the particular layer, an approximation of an adapter parameter matrix that includes fewer parameters than the adapter parameter matrix, wherein generating the approximation comprises:
generating, from the adapter parameter matrix, a plurality of butterfly factors;
generating, from a product of a first subset of the plurality of butterfly factors, a first matrix that comprises a plurality of diagonal matrix blocks;
generating, from the first matrix, a plurality of matrix blocks that each comprise one or more respective diagonal elements from each of the plurality of diagonal matrix blocks;
for each of the plurality of matrix blocks, performing low-rank factorization to factorize the matrix block into a first rank-s matrix and a second rank-s matrix;
generating, from a product of a second subset of the plurality of butterfly factors, a second matrix that comprises a plurality of repetitions of a matrix block along a diagonal of the second matrix; and
generating the approximation from the first matrix and the second matrix; and
training the adapted neural network on a machine learning task, wherein the adapting comprises learning fine-tuned values of parameters of the approximation using training data while holding the trained values in the base parameter matrix fixed.

19. The system of claim 18, wherein the trained neural network has a Transformer neural network architecture, and wherein the particular layer is an attention layer or a feed-forward layer included in the Transformer neural network architecture

20. One or more non-transitory computer storage media storing instructions that when executed by one or more computers cause the one more computers to perform operations comprising:
obtaining data specifying a trained neural network that includes a plurality of layers that include a particular layer, wherein the particular layer is associated with a base parameter matrix having trained values;
generating an adapted neural network, comprising generating, for the particular layer, an approximation of an adapter parameter matrix that includes fewer parameters than the adapter parameter matrix, wherein generating the approximation comprises:
generating, from the adapter parameter matrix, a plurality of butterfly factors;
generating, from a product of a first subset of the plurality of butterfly factors, a first matrix that comprises a plurality of diagonal matrix blocks;
generating, from the first matrix, a plurality of matrix blocks that each comprise one or more respective diagonal elements from each of the plurality of diagonal matrix blocks;
for each of the plurality of matrix blocks, performing low-rank factorization to factorize the matrix block into a first rank-s matrix and a second rank-s matrix;
generating, from a product of a second subset of the plurality of butterfly factors, a second matrix that comprises a plurality of repetitions of a matrix block along a diagonal of the second matrix; and
generating the approximation from the first matrix and the second matrix; and
training the adapted neural network on a machine learning task, wherein the adapting comprises learning fine-tuned values of parameters of the approximation using training data while holding the trained values in the base parameter matrix fixed.
